(19) United States
(12) Patent Application Publication
(10) Pub. No.: US 2012/0170962 A1
(43) Pub. Date: Jul. 5, 2012

(54) Writing instrument or stylus appendage for attachment with a finger

(76) Inventors: Augustine Nwapa-Jourdan, Los Angeles, CA (US); Eric McDonald, Garden Grove, CA (US); Jimmy Garrey, Fountain Valley, CA (US)

(21) Appl. No.: 12/930,234

(22) Filed: Dec. 29, 2010

(51) Int. Cl. B43K 23/00

(52) U.S. Cl. 401/8

(57) ABSTRACT

A Writing Instrument or Stylus Appendage for Attachment with a Finger includes a finger retainer, a member retainer, and a stem. The finger retainer and the member retainer are connected to each other by a stem. The second distal end of the stem is rounded to form a ball-socket joint which enables the articulation of the apparatus in a variety of angles and positions.

### FIELD OF THE INVENTION

The present invention is in the area of writing instruments, and styluses, and more particularly pertain to an apparatus for affixing such instruments with a person's finger with articulating rotation about an axis.

### BACKGROUND OF THE INVENTION

In today's digital age, we are increasingly encumbered with the juxtaposition of industrial tools with digital technology. For instance, the primary means of communication before 1950 was the pen or pencil. However, in today's world, most communication is transported through keyboards, and small pixilated buttons on a smart phone. And this juggling act is becoming increasingly vexatious for many people.

Most office workers, out of necessity have to sit in front of a computer screen in order to send or receive information. However, for many people, they must also have a pen or pencil handy for taking notes, signing contracts, and the like. As a result, many people have to constantly juggle between pencils, pens, styluses, and keyboards to accomplish substantially the same function: communicating.

Through this juggling many people lose their pens, fumble through their purses, pockets etc. in order to find them and take notes. And when they have to return to their computer screen they must also put them away. For some, the alternating use of pens, pencils, and the repetitive motion of typing keystrokes have led to serious physical maladies including repetitive motion injuries such as carpal tunnel syndrome.

Therefore, what is clearly needed in the art is an apparatus which enables people to retain a pen or other writing instrument on their fingers while enabling them to work with keyboards without having to set them aside. Such an apparatus should be scalable to accommodate many different instruments and different sizes of fingers.

### SUMMARY OF THE INVENTION

It is an object of the present invention to provide an apparatus to provide an apparatus that can be readily affixed to many different writing instruments or styluses. This apparatus will connect with a person's finger in a comfortable, yet secure manner. The user will be able to position it in a deployed position, and may articulate it or rotate it such that it will free them up to type on a computer or into a PDA.

### BRIEF DESCRIPTION OF THE DRAWING FIGURES

FIG. 1 is a perspective view of a preferred embodiment of the present invention.

FIG. 2 is a side elevation view of a preferred embodiment of the present invention.

FIG. 3 is a side elevation view of a preferred embodiment of the present invention.

FIG. 4 is a side elevation view of a preferred embodiment of the present invention.

FIG. 5 is a perspective view of a preferred embodiment of the present invention.

FIG. 6 is a perspective view of a preferred embodiment of the present invention.

FIG. 7 is a side view of a preferred embodiment of the present invention.

FIG. 8 is a perspective view of a preferred embodiment of the present invention.

FIG. 9 is a perspective view of a preferred embodiment of the present invention.

FIG. 10 is a perspective view of a preferred embodiment of the present invention.

FIG. 11 is a side-elevation view of a preferred embodiment of the present invention.

FIG. 12 is a side elevation view of a preferred embodiment of the present invention.

FIG. 13 is a side elevation view of a preferred embodiment of the present invention.

### DESCRIPTION OF PREFERRED EMBODIMENTS

According to a preferred embodiment of the present invention, a unique Writing Instrument or Stylus Appendage for Attachment with a Finger 100 is disclosed for the purpose of retaining a writing instrument or stylus on a person's finger. The present invention is described in enabling detail below.

For the purposes of the present invention, the term “writing instrument” shall be construed to include any instrument for writing such as pens, pencils, markers, and the like. In addition, it should be noted here that the present invention can be used in conjunction with various styluses which are used primarily for the purpose of interfacing with various touch-screens on PDA's and the like.

And in some preferred embodiments, the present invention may be used with laser pointers, and other office equipment that may or may not have a function of writing. For these reasons, the scope of the present invention should not be construed to be limited to only writing instruments or styluses.

FIG. 1 illustrates a preferred embodiment of the present invention. A Writing Instrument or Stylus Appendage for Attachment with a Finger 100 is comprised of a member retainer 103, a finger retainer 101, a stem 102, a plurality of expansion joints 105, and a plurality of flexible joints 104.

In some preferred embodiments, the stem 102 and member retainer 103 is replaced with a coupling 205 as illustrated in FIGS. 12-13. The coupling is simply any means of affixing the pen with the finger retainer. The coupling can be embodied in a panoply of different mechanisms. In some preferred embodiments the coupling may or may not need a bridge or link member affixed to the retaining appendage for the pen. And the retaining appendage for the pen may be embodied in a panoply of different materials. Some materials may be elastic, hard, plastic, metal, etc.

In some preferred embodiments the finger retainer 102 is affixed to the stem via the flexible joints. And the member retainer 101 is affixed to the stem. The stem is comprised of a first distal end 110 and a second distal end 111. The second distal end 111 of the stem is rounded and sized to mate, or to be retained within the flexible members.

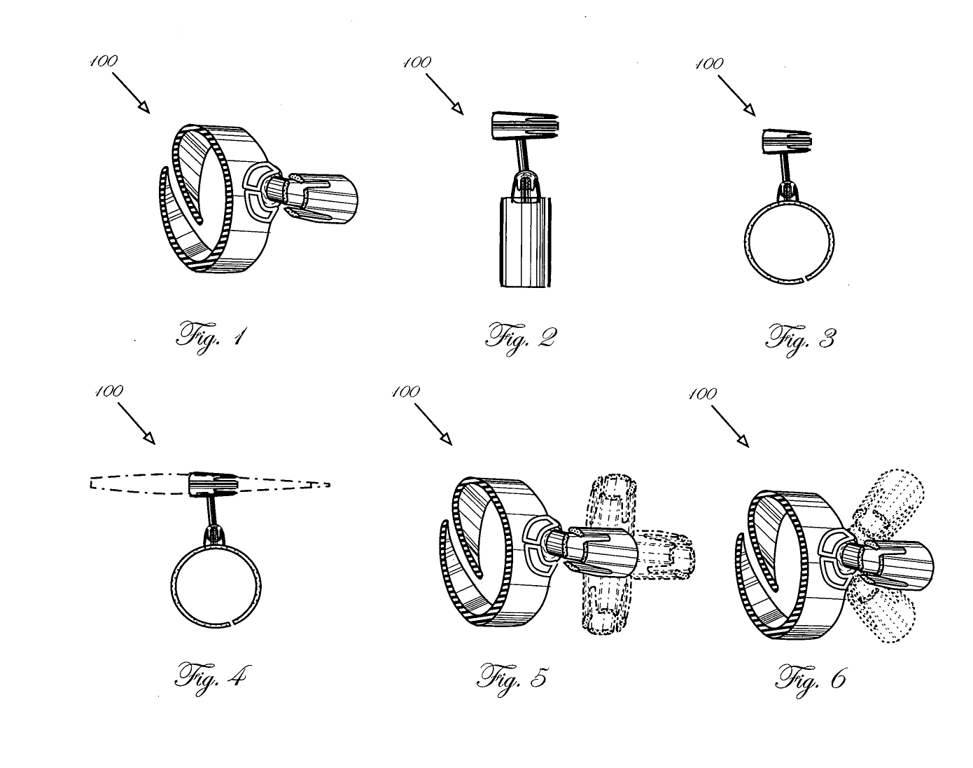

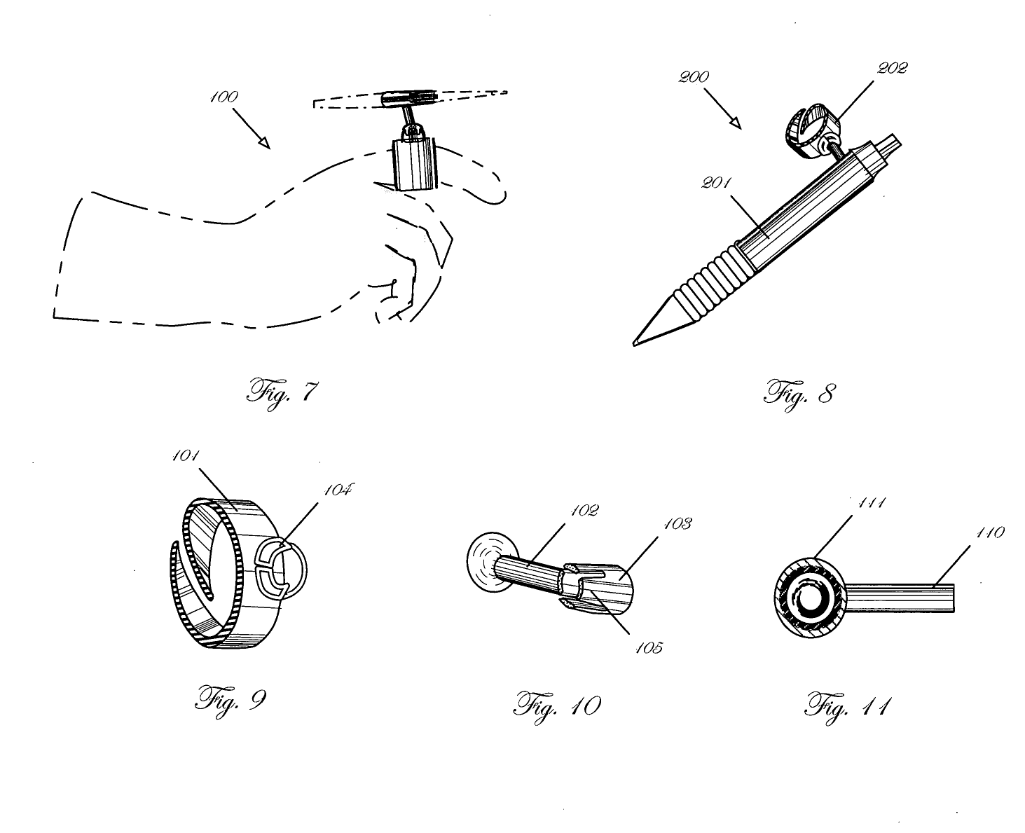

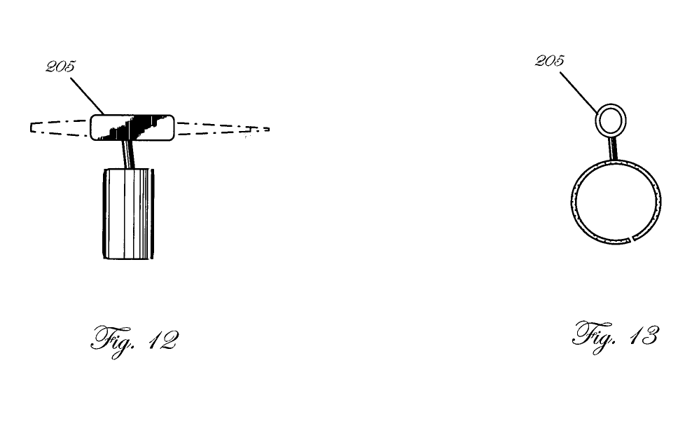

FIGS. 5-6 illustrate how the rounded distal end of the stem enables the writing instrument to be rotated around an axis. This ball-joint connection enables a rigid, yet flexible means of moving the writing instrument in a panoply of different angles and positions to best serve the user.

The finger retainer 102 is an elongated clamp in some preferred embodiments. The reason why the finger retainer 102 is not a completed cylinder is to enable for the expansion of its circumference or diameter to accommodate for several sizes of fingers. As such, the finger retainer 102 is comprised of a flexible, yet durable material.

In some preferred embodiments, this material may be comprised of hypo-allergenic material for some people with sensitive skin. In other preferred embodiments, the surface coating of the inner region of the finger retainer may be coated with a material which enables for smooth gliding of the finger retainer around the finger of a user.

As with the finger retainer 102, the member retainer 101 comprises a plurality of expansion joints 104. These expansion joints 104, in some preferred embodiments, are essentially cuts into the cylinder of the member retainer 101. These expansion joints 104 are incorporated for the purpose of enabling the member retainer 101 to accommodate a variety of different sized pens, pencils, styluses, etc.

FIG. 8 illustrates that in some preferred embodiments, an articulating writing instrument apparatus 200 comprises a writing instrument 201, and a finger attachment 202. This preferred embodiment illustrates that the finger attachment may alternatively be fused with a writing instrument or stylus directly without use of a member retainer. Moreover, in this preferred embodiment, the writing instrument may further include functions for the purpose of leaving the working end of the pen in a deployed, or a retained position.

It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A Writing Instrument or Stylus Appendage for Attachment with a Finger comprising:
a member retainer, a finger retainer, and a stem;
the member retainer is affixed with the stem; the member retainer comprises a stem retainer;
the stem is affixed with the finger retainer.

2. The Writing Instrument or Stylus Appendage for Attachment with a Finger of claim 1 wherein the stem comprises a first distal end and a second distal end; the second distal end is rounded and sized to be retained within the stem retainer.

3. The Writing Instrument or Stylus Appendage for Attachment with a Finger of claim 1 further wherein the finger retainer is comprised of an elongated clamp.

4. The Writing Instrument or Stylus Appendage for Attachment with a Finger of claim 1 wherein the member retainer comprises a plurality of expansion joints.

5. The Writing Instrument or Stylus Appendage for Attachment with a Finger of claim 1 wherein the stem retainer is comprised of a plurality of flexible joints.

6. A Writing Appendage comprising a coupling, and a finger retainer.
